(19) United States
(12) Patent Application Publication
(10) Pub. No.: US 2005/0154161 A1
(43) Pub. Date: Jul. 14, 2005

(54) Method for producing highly transparent plastics for optical materials

(75) Inventors: Bardo Schmitt, Mainz (DE); Joachim Knebel, Alsbach-Haehnlein (DE); Patrik Hartmann, Buettelborn (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: ROEHM GMBH & CO. KG, Darmstadt (DE)

(21) Appl. No.: 10/509,328

(22) PCT Filed: Jun. 13, 2003
(86) PCT No.: PCT/EP03/06271

(30) Foreign Application Priority Data
Jul. 12, 2002 (DE) 102 31 869.7
Apr. 10, 2003 (DE) 103 16 671.8

(51) Int. Cl. C08F 2/00

(52) U.S. Cl. 526/222; 526/319

(57) ABSTRACT

The present invention relates to a process for preparing a highly transparent plastic obtainable by free-radical copolymerization of a mixture containing compounds of the formula (I) and (II) 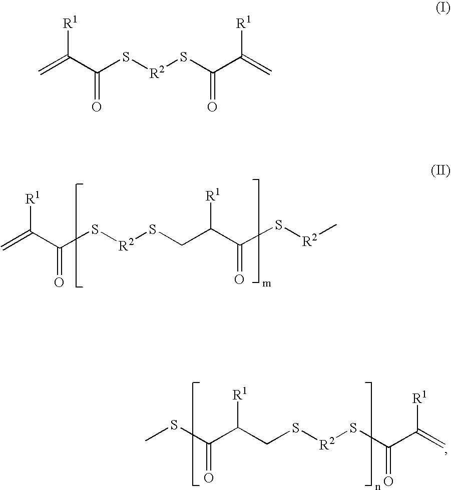
where R¹ is independently at each instance hydrogen or a methyl radical,
R² is independently at each instance a linear or branched, aliphatic or cycloaliphatic radical or a substituted or unsubstituted aromatic or heteroaromatic radical and
m and n are each independently an integer of not less than 0 subject to the proviso that m+n>0,
which is characterized in that it is obtainable from a mixture which contains more than 10 mol %, based on the total amount of the compounds of the formula (I) and (II), of compounds of the formula (II) where m+n=2. The present invention also relates to the mixture of the compounds (I) and (II), to processes for preparing the mixture and to particular uses for the highly transparent plastics.

The present invention relates to a process for preparing transparent plastics. More particularly, the invention relates to highly transparent plastics useful for preparing optical, especially ophthalmic, lenses.

Spectacles have become everyday articles. Especially spectacles having plastic glasses have gained importance in recent times since they are lighter and less fragile than spectacle glasses made of inorganic materials and can be coloured with suitable dyes. Plastic glasses for spectacles are generally produced using highly transparent plastics which are obtainable for example starting from diethylene glycol bis(allyl carbonate) (DAC), thiourethane compounds having α,ω-terminated multiple bonds or sulphur-containing (meth)acrylates.

DAC plastic exhibits very good impact toughness, transparency and good processibility. However, it is disadvantageous that, owing to the relatively low refractive index n_{D} of about 1.50, not only the centre but also the edges of the plastic glasses in question have to be reinforced, so that the spectacle glasses are correspondingly thick and heavy. The wear comfort of spectacles having DAC plastic glasses is therefore distinctly reduced.

Thiourethane prepolymers having α,ω-terminated multiple bonds, which are obtained by reaction of α,ω-di-functional thiourethane prepolymers bearing two isocyanate groups with unsaturated compounds possessing Zerevitinov-active H atoms, are described for example in DD 298645. Possible applications mentioned for the thiourethane prepolymers are transparent layers or firmly adherent films. DD 298645 does not disclose any use as optical and ophthalmic lenses.

JP 5-215995 describes plastic spectacle glasses obtained by radical copolymerization of a ternary composition of an α,ω-di(meth)acrylate-terminated thiourethane compound having S-(phenyl-S)₂ units, tri-methylolpropane tris(betathiopropionate) and divinyl-benzene. Although the refractive index of the resultant plastics is relatively large (n_{D}≧1.58), the glasses have the disadvantage of a comparatively low Abbe number in the range from 28 to 36. An excessively low Abbe number leads to a higher dispersion and to coloured edges, and corresponding plastic glasses therefore have only limited usefulness as a visual aid. JP 5-215995 is silent on the impact toughness of the plastic glasses and on their Vicat temperature.

The same applies to the plastics disclosed in WO 01/36506, which are obtained by free-radical polymerization of monomers having at least two (meth)acryloyl groups and wherein the monomers further have thiourethane and/or dithiourethane linkages within the molecule. The exemplified polymer has a refractive inaex of 1.60 and an Abbe number of 34 to 35. This reference too is silent on the Vicat temperature of the plastics.

A further group of transparent plastics for optical applications is disclosed in EP 0810210. The sulphur-containing (meth)acrylate monomers used, in contrast to the compounds described above, are formally derived not from the hydroxyalkyl (meth)acrylates but from the mercaptoalkyl (meth)acrylates. The plastics described in EP 0810210 comprise an improved impact toughness and a high refractive index nD in the range from 1.589 to 1.637. Compared with the plastics described in JP 5-215995, the Abbe number is only slightly up at between 27.5 and 40.7. For this reason, the plastics disclosed in EP 0810210 have only limited usefulness for spectacle glasses. Nor does this reference disclose any information with regard to the Vicat temperature of the plastics.

DE 4234251 discloses sulphur-containing polymethacrylates which are obtained by free-radical copolymerization of a monomer mixture comprising compounds of the formula (1) and (2).

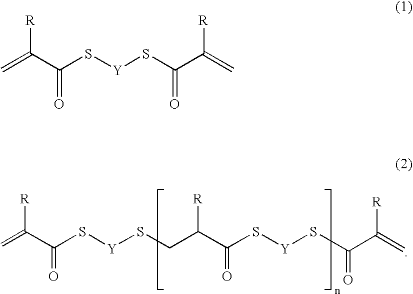

In these formulae, Y is an optionally branched, optionally cyclic alkyl radical having 2 to 12 carbon atoms or an aryl radical having 6 to 14 carbon atoms or an alkaryl radical having 7 to 20 carbon atoms, wherein the carbon chains may be interrupted by one or more ether or thioether groups. R represents hydrogen or methyl and n is an integer from 1 to 6.

In DE 4234251, the monomers of the formula (1) and (2) are generally in a molar ratio of 1:0.5 to 0.5:1. The monomer mixture is prepared by reacting at least two moles of (meth)acryloyl chloride or (meth)acrylic anhydride with one mole of a dithiol, the methacryloyl chloride or methacrylic anhydride in an inert organic solvent and the dithiol in an aqueous alkaline solution. Solvents mentioned as useful include methyl tert-butyl ether, toluene and xylene, the dielectric constant of which is respectively 2.6, 2.4 and 2.3-2.6 at 20° C.

The plastics described in DE 4234251 are colourless, rigid and somewhat brittle and have a high refractive index n_{D} in the range from 1.602 to 1.608. The Abbe number is between 35 and 38. Therefore, these plastics too have only limited usefulness for spectacle glasses. Again, this reference does not disclose any information with regard to the Vicat temperature of the plastics.

Against that background, it is an object of the present invention to provide a process for preparing a highly transparent plastic having a very high refractive index, preferably above 1.608, and a very high Abbe number, preferably above 36, that makes it possible to prepare optical lenses. More particularly, the plastic spectacle glasses preparable shall possess low dispersion and no coloured edges.

It is a further object to provide a process for preparing a highly transparent plastic having improved mechanical properties, such as good impact toughness. Preferably, the ISO 179/lfU Charpy impact toughness of the plastic shall be greater than 3.0 kJ/m.

It is another object of the present invention to provide a process for preparing a highly transparent plastic having improved mechanical properties at temperatures above room temperature as well as at room temperature. More particularly, the plastic of the invention shall have a very high ISO 306 Vicat temperature, preferably greater than 50.0° C.

It is yet another object of the present invention that the highly transparent plastic which is preparable by the process according to the invention shall be preparable in a manner that is simple, on an industrial scale and inexpensive. More particularly, the highly transparent plastic of the invention shall be obtainable from at least one monomer which is flowable at standard pressure and temperatures in the range from 20.0° C. to 80.0° C., via free radical polymerization.

It is still a further object of the present invention to indicate areas of application and possible uses for the highly transparent plastic preparable by the process of the invention.

These and other objects not explicitly mentioned but readily derivable or reconstructable from the above context are achieved by a process for preparing a highly transparent plastic having all the features of claim 1. Advantageous modifications of the process for preparing the plastic are protected in subclaims appendant to claim 1. The use category claim protects a preferred use of the highly transparent plastic preparable using the process according to the invention. An optical, preferably ophthalmic, lens comprising the highly transparent plastic according to the invention is described in a further product claim. By providing a process for preparing a highly transparent plastic which is obtainable by free-radical polymerization of a mixture containing compounds of the formula (I) and (II) 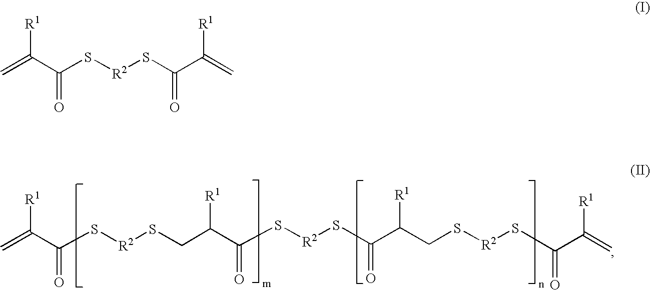
where R¹ is independently at each instance hydrogen or a methyl radical,
R² is independently at each instance a linear or branched, aliphatic or cycloaliphatic radical or a substituted or unsubstituted aromatic or heteroaromatic radical and
m and n are each independently an integer of not less than 0 subject to the proviso that m+n>0,
and which is characterized in that the highly transparent plastic is obtainable from a mixture which contains more than 10 mol %, based on the total amount of the compounds of the formula (I) and (II), of compounds of the formula (II) where m+n=2. A highly transparent plastic is made available by the process in an unforeseeable manner that is very useful for optical, especially ophthalmic, lenses. The highly transparent plastic of the invention comprises a previously unknown combination of outstanding properties, such as a high refractive index, a high Abbe number, a good Charpy impact toughness and a high Vicat temperature. The corresponding plastic spectacle glasses exhibit low dispersion; there are no coloured edges.

The highly transparent plastic obtainable using the process of the invention possesses yet further advantages. These include:
[symbol] O-wing to the high refractive index of the plastic according to the invention which is obtainable using the process, there is no need for the centre and edges of corresponding plastic spectacle glasses to be reinforced and thus thickened, the wear comfort of such spectacles is distinctly improved by the comparatively low weight.
[symbol] The good impact toughness of the plastic according to the invention which is obtainable using the process protects the corresponding plastic spectacle glasses against everyday dangers. Damage or irreparable destruction, especially of thin spectacle glasses by mechanical force is substantially prevented.
[symbol] The highly transparent plastic of the invention possesses a high ISO 306 Vicat temperature of preferably greater than 50.0° C. and therefore retains its excellent mechanical properties, especially the high impact strength and its hardness, up to this temperature.
[symbol] The highly transparent plastic obtainable using the process of the invention is simply, industrially and inexpensively preparable by free radical copolymerization of a monomer mixture which is preferably flowable at standard pressure and temperatures in the range from 20.0° C. to 80.0° C.
[symbol] The underlying monomer mixture is likewise simple and inexpensive to prepare on an industrial scale.

The present invention concerns a process for preparing a highly transparent plastic. The plastic of the invention preferably has a DIN 5036 transmission of at least 89.0%.

The highly transparent plastic obtainable using the process according to the invention is obtainable by free radical copolymerization of a monomer mixture which is preferably flowable at standard pressure and temperatures in the range from 20.0° C. to 80.0° C. Free radical copolymerization is a well-known process initiated by free radicals for converting a mixture of low molecular weight monomers into high molecular weight compounds, so-called polymers. For further details see the disclosure of H. G. Elias, Makromoleküle, volumes 1 and 2, Basle, Heidelberg, New York Hüthig und Wepf. 1990 and Ullmann's Encyclopedia of Industrial Chemistry, 5th edition, polymerization processes.

In a preferred embodiment of the present invention, the plastic of the invention is obtainable by mass or bulk polymerization of the monomer mixture. A mass or bulk polymerization is a polymerization process in which monomers are polymerized without solvent, so that the polymerization reaction proceeds in the mass or bulk. This is in contrast to the polymerization in emulsion (so-called emulsion polymerization) and the polymerization in dispersion (so-called suspension polymerization), where the organic monomers are suspended in an aqueous phase using protective colloids and/or stabilizers and more or less coarse polymer particles are formed. A particular form of the polymerization in heterogeneous phase is bead polymerization, which is essentially a suspension polymerization.

The polymerization reaction can in principle be initiated in any manner familiar to one skilled in the art, for example using a radical initiator (for example peroxide, azo compound) or by irradiation with UV rays, visible light, α rays, β rays or γ rays or a combination thereof.

In a preferred embodiment of the present invention, the polymerization is initiated using lipophilic radical polymerization initiators. The radical polymerization initiators are therefore especially lipophilic so that they may dissolve in the mixture of the bulk polymerization. Useful compounds include not only the classic azo initiators, such as azoisobutyronitrile (AIBN) or 1,1-azobiscyclohexanecarbonitrile, but also aliphatic peroxy compounds, for example tert-amyl peroxyneodecanoate, tert-amyl peroxypivalate, tert-butyl peroxypivalate, tert-amyl peroxy-2-ethyl-hexanoate, tert-butyl peroxy-2-ethylhexanoate, tert-amyl peroxy-3,5,5-trimethylhexanoate, ethyl 3,3-di-(tert-amylperoxy)butyrates, tert-butyl perbenzoate, tert-butyl hydroperoxide, decanoyl peroxide, lauryl peroxide, benzoyl peroxide and any mixtures of the compounds mentioned. Of the aforementioned compounds, AIBN is very particularly preferred.

In a further preferred embodiment of the present invention, the polymerization is initiated using known photoinitiators by irradiation with UV rays or the like. Useful compounds include the widely used and commercially available compounds such as for example benzophenone, α,α-diethoxyacetophenone, 4,4-diethyl-aminobenzophenone, 2,2-dimethoxy-2-phenylacetophenone, 4-isopropylphenyl 2-hydroxy-2-propyl ketone, 1-hydroxy-cyclohexyl phenyl ketone, isoamyl p-dimethylamino-benzoate, methyl 4-dimethylaminobenzoate, methyl o-benzoylbenzoate, benzoin, benzoin ethyl ether, benzoin isopropyl ether, benzoin isobutyl ether, 2-hydroxy-2-methyl-1-phenylpropan-1-one, 2-isopropyl-thioxanthone, dibenzosuberone, 2,4,6-trimethylbenzoyl-diphenylphosphine oxide, bisacylphosphine oxide and others, and the photoinitiators mentioned may be used alone or in combination of two or more or in combination with one of the above polymerization initiators.

The amount of radical formers can vary within wide limits. Preference is given to using for example amounts in the range from 0.1 to 5% by weight, based on the weight of the total composition. Particular preference is given to amounts in the range from 0.1 to 2% by weight, especially amounts in the range from 0.1 to 0.5% by weight, each percentage being based on the weight of the total composition.

The polymerization temperature to be chosen for the polymerization is evident to one skilled in the art. It is primarily determined by the choice of initiator and by the method of initiation (thermally, by irradiation and so on). It is known that the polymerization temperature can influence the product properties of a polymer. For this reason, the preference of the present invention is for polymerization temperatures in the range from 20.0° C. to 100.0° C., advantageously in the range from 20.0° C. to 80.0° C. and especially in the range from 20.0° C. to 60.0° C. In a particularly preferred embodiment of the present invention, the reaction temperature is raised during the reaction, preferably in stages. It will further be advantageous to carry out a heat treatment at elevated temperature, for example at 100° C., towards the end of the reaction.

The reaction can take place not only at reduced pressure but also at superatmospheric pressure. But preferably it is conducted at atmospheric pressure. The reaction can take place under air and also under protective gas atmosphere, in which case it is preferable for a very small fraction of oxygen to be present, since it inhibits a possible polymerization.

In a particularly preferred embodiment of the present invention, the highly transparent plastic of the invention is prepared by preparing a homogeneous mixture of the monomer mixture, initiator and further additives, for example lubricants, and subsequently placrig this homogeneous mixture between glass plates whose shape is predetermined by the later application, for example as lenses, spectacle glasses, prisms or other optical components. The bulk polymerization is initiated by energy supply, for example by high energy radiation, especially using UV light, or by heating, conveniently in a waterbath for several hours. This provides the optical material in its desired shape as a clear, transparent, colourless, rigid plastic.

For the purposes of the present invention, lubricants are additives for filled plastically deformable compositions, such as compression moulding compounds and injection moulding compounds, to lubricate the fillers and make the compression moulding compounds consequently more easily mouldable. These include for example metal soaps and siloxane combinations. Owing to its insolubility in plastics, a portion of the lubricant migrates to the surface in the course of processing and acts as a release agent. Particularly suitable lubricants, such as nonionic fluoro-surfactants, nonionic silicone surfactants, quaternary alkylammonium salts and acidic phosphate esters, are described in EP 271839 A, the disclosure of which is explicitly incorporated herein by reference.

For the purposes of the present invention, the monomer mixture for the free-radical polymerization is preferably flowable at standard pressure and temperatures in the range from 20.0° C. to 80.0° C. The term “flowable” is familiar to one skilled in the art. It characterizes a more or less viscous liquid which is preferably castable into various shapes and stirrable and homogenizable using suitable assistants. Particular flowable compositions for the purposes of the invention have in particular at 25° C. and standard pressure (101 325 Pa) dynamic viscosities of the order of 0.1 mPa·s to 10 Pa·s and advantageously in the range from 0.65 mPa·s to 1 Pa·s. In a very particularly preferred embodiment of the present invention, a cast monomer mixture is free of bubbles, especially air bubbles. Preference is likewise given to monomer mixtures from which bubbles, especially air bubbles, are removable by suitable methods, for example temperature elevation and/or application of vacuum.

The plastic of the present invention which is obtainable using the process preferably has a refractive index n_{D}>1.608, in particular greater than 1.61. The refractive index n_{D} is a variable which is known to one skilled in the art and which, according to the invention, characterizes the deflection (change of direction) which a ray of light suffers on passing at an angle from an optically different medium, for example air, into the highly transparent plastic of the invention, in which its speed of propagation (c=velocity of light in the vacuum, c/n=velocity of light in the medium having refractive index n) differs. Snell first formulated his law of refraction in 1615:

$$\frac{sin α}{sin β} = \frac{{n}_{2}}{{n}_{1}}$$

where n₁ and n₂ are the refractive indices of the two media 1 and 2 respectively, α is the angle of incidence in medium 1 and β is the angle of incidence in medium 2.

The refractive index of a medium generally depends on the wavelength of the incident radiation and on the temperature. The refractive index data of the invention are therefore based on the standards specified in DIN 53491 (standard wavelength of the (yellow) D line of sodium (about 589 nm)).

According to the present invention, the plastic obtainable using the process preferably has a DIN 53491 Abbe number>36.0. The Abbe number goes back to E. Abbe and refers to a variable v_{D}

$${v}_{D} = \frac{( {n}_{D} - 1 )}{( {n}_{F} - {n}_{C} )}$$

being introduced to characterize the dispersive power of an optical medium. n_{D}, n_{F} and n_{C} are the refractive indices of the medium at the Fraunhofer D, F and C lines respectively. D is the average value of the sodium D lines λ₁=589.6 nm and λ₂=589.0 nm, F is the hydrogen line at λ=486.1 nm and C is the hydrogen line at λ=656.3 nm. A large Abbe number denotes low dispersion. Further information concerning the Abbe number is available to the skilled person from the literature, for example Lexikon der Physik (Walter Greulich (editor); Lexikon der Physik; Heidelberg; Spektrum, Akademischer Verlag; volume 1; 1998).

In a particularly preferred embodiment of the present invention, the plastic has an Abbe number >36.0, advantageously >37.0, especially >38.0. Plastics having an Abbe number >39.0 and preferably >40.0 have been found to be very particularly advantageous. According to the invention, plastics having an Abbe number >41.0 and especially >42.0 are of the greatest interest.

For the purposes of the present invention, the highly transparent plastic is obtainable from a mixture which comprises compounds of the formula (I) and (II) 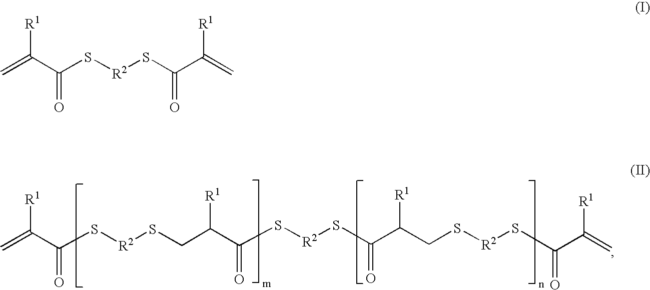
where R¹ is at each instance independently hydrogen or a methyl radical, preferably a methyl radical.

R² is at each instance independently a linear or branched, aliphatic or cycloaliphatic radical or a substituted or unsubstituted aromatic or heteroaromatic radical, for example a methylene, ethylene, propylene, isopropylene, n-butylene, isobutylene, t-butylene or cyclohexylene group or divalent aromatic or hetero-aromatic groups derived from benzene, naphthalene, diphenyl, diphenyl ether, diphenylmethane, diphenyl-dimethylmethane, bisphenone, diphenyl sulphone, quinoline, pyridine, anthracene and phenanthrene. Cycloaliphatic radicals for the purposes of the present invention also comprehend bi-, tri- and polycyclic aliphatic radicals.

The radical R² further comprehends radicals of the formula
R³—X_{y}R⁴. (Ia)
where R³ is independently a linear or branched, aliphatic or cycloaliphatic radical, for example a methylene, ethylene, propylene, isopropylene, n-butylene, iso-butylene, t-butylene or cyclohexylene group. Each X is independently oxygen or sulphur and R⁴ represents a linear or branched, aliphatic or cycloaliphatic radical, for example a methylene, ethylene, propylene, isopropylene, n-butylene, isobutylene, t-butylene or cyclohexylene group. Cycloaliphatic radicals for the purposes of the present invention also comprehend bi-, tri- and polycyclic aliphatic radicals. y is an integer between 1 and 10, especially 1, 2, 3 and 4.

Preferred radicals of the formula (Ia) include: 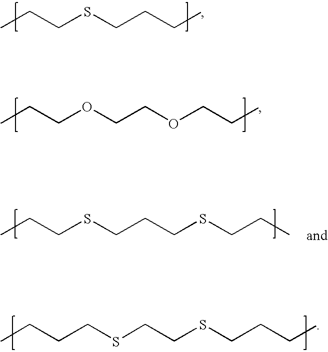
R² is preferably an aliphatic radical of 1 to 10 carbon atoms, preferably a linear aliphatic radical of 2 to 8 carbon atoms.

The indices m and n are each independently an integer of not less than 0, for example 0, 1, 2, 3, 4, 5 or 6. This is subject to the proviso that the sum m+n is greater than 0, preferably in the range from 1 to 6, advantageously in the range from 1 to 4 and especially 1, 2 or 3.

It is necessary for the purposes of the present invention that the mixture should contain more than 10 mol %, preferably more than 12 mol % and especially more than 14 mol %, based on the total amount of the compounds of the formula (I) and (II), of compounds of the formula (II) where m+n=2.

The compounds of the formula (I) and also the compounds of the formula (II) can each be used individually or else as a mixture of plural compounds of the formulae (I) and (II).

The composition of the monomer mixtures according to the present invention is in principle arbitrary and it can be used to tailor the performance profile of the plastic of the present invention to the requirements of the intended use. For example, it can be extremely advantageous for the monomer mixture to contain a distinct excess or a compound or compounds of the formula (I) or a compound or compounds of the formula (II).

However, it has been determined to be extremely advantageous to choose the composition of the monomer mixture such that the at least one compound of the formula (I) and the at least one compound of the formula (II) form a homogeneous mixture at the desired polymerization temperature, since such homogeneous mixtures are easily handleable owing to their generally low viscosity and, what is more, can be polymerized to homogeneous plastics having improved material properties.

It is further particularly beneficial according to the present invention to use mixtures in the process which contain more than 5.8 mol %, advantageously more than 6.5 mol % and especially more than 7.5 mol %, based on the total amount of the compounds of the formula (I) and (II), of compounds of the formula (II) where m+n=3. The fraction of compounds (I) is preferably in the range from 0.1 to 50.0 mol %, advantageously in the range from 10.0 to 45.0 mol % and especially in the range from 20.0 to 35.0 mol %, based on the total amount of compounds of the formula (I) and (II). The fraction of compounds (II) where m+n=1 is preferably above 20.0 mol %, advantageously above 30.0 mol %, even more advantageously above 35.0 mol % and especially above 40 mol %, based on the total amount of compounds of the formula (I) and (II). The fraction of compounds (II) where m+n>3 is preferably above 0 mol %, advantageously above 1 mol % and especially above 2 mol %, based on the total amount of compounds of the formula (I) and (II).

Processes for preparing the monomer compositions of the present invention will be immediately obvious to one skilled in the art. For example, they can be obtained by single- or multi-staged mixing of the individual components. Nonetheless, it has been determined to be particularly beneficial in the context of the present invention for the monomer mixtures according to the present invention to be prepared by a process in which 1.0 to <2.0 mol, preferably 1.1 to 1.8 mol, advantageously 1.2 to 1.6 mol and especially 1.2 to 1.5 mol of at least one compound of the formula (III) 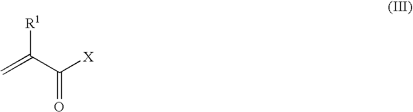
are reacted with with one mole of at least one polythiol of the formula (IV)

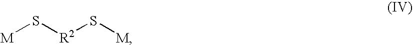

The X radical represents chlorine or a radical 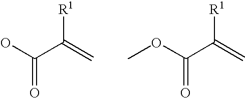
i.e. the compounds of the formula (III) encompass acryloyl chloride, methacryloyl chloride, acrylic anhydride and methacrylic anhydride, and the use of acrylic anhydride, methacrylic anhydride or mixtures thereof is particularly preferred.

M is at each instance independently hydrogen or a metal cation. Preferred metal cations are derived from elements having an electronegativity of less than 2.0 and advantageously of less than 1.5, and alkali metal cations, especially Na⁺, K⁺, Rb⁺ and Cs⁺ and alkaline earth metal cations, especially Mg²⁺, Ca²⁺, Sr²⁺ and Ba²⁺, are particularly preferred. Very particularly beneficial results are obtainable with the metal cations Na⁺ and K⁺.

Polythiols of the formula (IV) which are particularly suitable according to the present invention include 1,2-ethanedithiol, 1,2-propanedithiol, 1,3-propanedithiol, 1,2-butanedithiol, 1,3-butanedithiol, 1,4-butanedithiol, 2-methylpropane-1,2-dithiol, 2-methyl-propane-1,3-dithiol, 3,6-dioxa-1,8-octanedithiol, ethyl-cyclohexyl dimercaptans obtainable by reaction of 4-ethenylcyclohexene with hydrogen sulphide, ortho-bis-(mercaptomethyl)benzene, meta-bis(mercaptomethyl)benzene, para-bis(mercaptomethyl)benzene, compounds of the formula 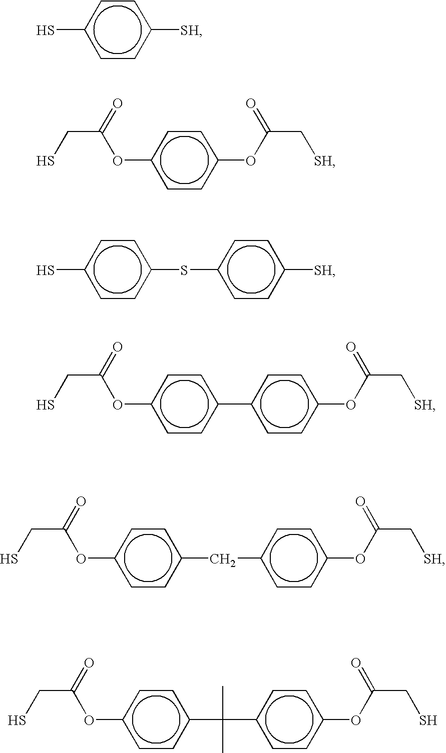
and also compounds of the formula
HSR³—X_{y}R⁴SH, (Iva)
where each R³ is independently a linear or branched, aliphatic or cycloaliphatic radical, for example a methylene, ethylene, propylene, isopropylene, n-butylene, isobutylene, t-butylene or cyclohexylene group. Cycloaliphatic radicals for the purposes of the present invention also comprehend bi-, tri- and polycyclic aliphatic radicals. Each X is independently oxygen or sulphur and R⁴ represents a linear or branched, aliphatic or cycloaliphatic radical, for example a methylene, ethylene, propylene, isopropylene, n-butylene, isobutylene, t-butylene or cyclohexylene group. Cycloaliphatic radicals for the purposes of the present invention also comprehend bi-, tri- and polycyclic aliphatic radicals. y is an integer between 1 and 10, especially 1, 2, 3 and 4.

Preferred compounds of the formula (IVa) include:

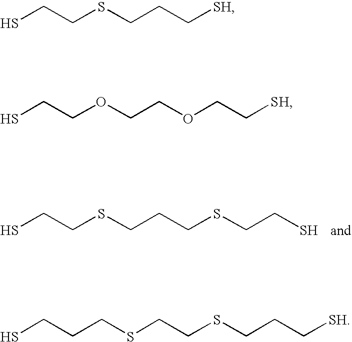

A very particularly preferred embodiment of the present invention utilizes 1,2-ethanedithiol as a compound of the formula (IV).

According to the present invention, the compound or compounds of the formula (III) is(are) reacted in at least one inert organic solvent L and the compound or compounds of the formula (IV) in an aqueous alkaline solution, the term “inert organic solvent” denoting organic solvents which do not react with the compounds in the reaction system under the particular reaction conditions.

For the purposes of the present invention, at least one solvent L shall have a relative dielectric constant >2.6, preferably >3.0, advantageously >4.0 and especially >5.0, measured at 20° C. in each case. In this context, the relative dielectric constant is a dimensionless number which indicates by how much the capacitance C of a (theoretical) evacuated condenser increases on introducing a dielectric between the plates. This value is measured at 20° C. and extrapolated to low frequencies (ω→0). For further details, reference is made to the usual technical literature, especially to Ullmann Encyklopädie der technischen Chemie, volume 2/1 Anwendung physikalischer und physikalisch-chemischer Methoden im Laboratorium, “Dielektrizitätskonstante”, pp. 455-479. Dielectric values of solvents are reported inter alia in the Handbook of Chemistry and Physics, 71st edition, CRC Press, Baco Raton, Ann Arbor, Boston, 1990-1991, pp. 8-44, 8-46 and 9-9 to 9-12.

It is further particularly advantageous for the purposes of the present invention for the solvent and the aqueous solution to form two phases during the reaction and not to be homogeneously miscible. For this purpose, the solvent preferably has a water solubility (as measured at 20° C.) of less than 10 g of water based on 100 g of solvent.

Solvents L which are preferred according to the present invention include
aliphatic ethers, such as diethyl ether (4.335), dipropyl ether, diisopropyl ether;
cycloaliphatic ethers, such as tetrahydrofuran (7.6);
aliphatic esters, such as methyl formate (8.5), ethyl formate, propyl formate, methyl acetate, ethyl acetate, n-butyl acetate (5.01), methyl propionate, methyl butyrate (5.6), ethyl buryrate, 2-methoxyethyl acetate;
aromatic esters, such as benzyl acetate, dimethyl phthalate, methylbenzoate (6.59), ethyl benzoate (6.02), methyl salicylate, ethyl salicylate, phenyl acetate (5.23);
aliphatic ketones, such as acetone, methyl ethyl ketone (18.5), 2-pentanone (15.4), 3-pentanone (17.0), methyl isoamyl ketone, methyl isobutyl ketone (13.1);
aromatic ketones, such as acetophenone;
nitroaromatics, such as nitrobenzene, o-nitrotoluene (27.4), m-nitrotoluene (23), p-nitrotoluene;
halogenated aromatics, such as chlorobenzene (5.708), o-chlorotoluene (4.45), m-chlorotoluene (5.55), p-chlorotoluene (6.08), o-dichlorobenzene, m-dichloro-benzene;
heteroaromatics, such as pyridine, 2-methylpyridine (9.8), quinoline, isoquinoline;
   or mixtures thereof, and the numbers in parentheses denote the respective, associated relative dielectric constants at 20° C.

For the purposes of the present invention, aliphatic esters and cycloaliphatic ethers, especially ethyl acetate and tetrahydrofuran, are very particularly suitable.

In the present invention, the solvent L can be used not only alone but also as a solvent mixture, in which case not all the solvents present in the mixture have to meet the above dielectric criterion. For example, it is also possible to use tetrahydrofuran/cyclohexane mixtures according to the present invention. However, it has been determined to be advantageous for the solvent mixture to have a relative dielectric constant >2.6, preferably >3.0, advantageously >4.0 and especially >5.0, measured at 20° C. in each case. Particularly advantageous results can be achieved with solvent mixtures which exclusively contain solvents having a relative dielectric constant >2.6, preferably >3.0, advantageously >4.0 and especially >5.0, measured at 20° C. in each case.

The aqueous alkaline solution of the compound or compounds of the formula (IV) preferably contains 1.1 to 1.5 equivalents of at least one Bronsted base, based on the total amount of compound or compounds of the formula (III). Preferred Bronsted bases for the purposes of the present invention include alkali metal hydroxides and alkaline earth metal hydroxides, especially sodium hydroxide and potassium hydroxide.

The reaction may in principle be carried out in any conceivable manner. For example, it is possible for the compound or compounds of the formula (III) to be introduced as an initial charge in the solvent or solvent mixture L and for the aqueous alkaline solution of the compound or compounds of the formula (IV) to be added stepwise or continuously. Nevertheless, it has been determined to be very particularly beneficial for the present invention when the compound or compounds of the formula (III) and the compound or compounds of the formula (IV) are concurrently metered into the reaction vessel in at least one inert organic solvent L and in an aqueous alkaline solution, respectively.

The reaction temperature can be varied over a wide range, but frequently the temperature will be in the range from 20.0° C. to 120.0° C., and preferably in the range from 20.0° C. to 80.0° C. The same is true of the pressure at which the reaction is carried out. Thus, the reaction can be carried out not only at subatmospheric pressure but also at superatmospheric pressure. But preferably it will be carried out at atmospheric pressure. Although the reaction can also take place under air, it has been determined to be very particularly beneficial for the present invention for the reaction to be carried out under protective gas atmosphere, preferably nitrogen and/or argon, although it is preferable for a small oxygen fraction to be present.

It is beneficial for the reaction mixture to be reacted with a Bronsted acid in a further step until the aqueous solution has a pH at 20° C. which is preferably less than 7.0, advantageously less than 6.0 and especially less than 5.0. Useful acids in this connection include inorganic mineral acids, such as hydrochloric acid, sulphuric acid, phosphoric acid, organic acids, such as acetic acid, propionic acid, and acidic ion exchangers, especially acidic synthetic resin ion exchangers, such as ®Dowex M-31 (H) for example. The use in this connection of acidic synthetic resin ion exchangers having loadings of at least 1.0 meq, preferably at least 2.0 meq and especially at least 4.0 meq of H⁺ ions based on 1 g of dried ion exchanger, particle sizes of 10-50 mesh and porosities in the range from 10 to 50% based on the total volume of the ion exchanger has been determined to be very particularly suitable.

To isolate the compounds of the formula (I) and (II), it is advantageous for the organic phase, which consists of the solvent L, to be separated off, washed if necessary, dried and the solvent evaporated.

The reaction of the compound or compounds of the formula (III) with the compound or compounds of the formula (IV) may be carried out in the presence of inhibitors to prevent any radical polymerization of the (meth)acryloyl groups during the reaction. These inhibitors are well known to those skilled in the art.

1,4-Dihydroxybenzenes are used in the main. However, differently substituted dihydroxybenzenes can be used as well. In general, such inhibitors can be represented by the general formula (V) 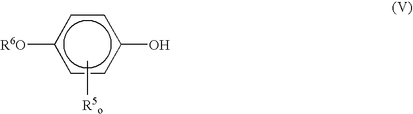
where
R⁵ is a linear or branched alkyl radical of one to eight carbon atoms, halogen or aryl, preferably an alkyl radical of one to four carbon atoms, particularly preferably methyl, ethyl, n-propyl, isopropyl, n-butyl, isobutyl, sec-butyl, tert-butyl, Cl, F or Br;
o is an integer from one to four, preferably one or two; and
R⁶ is hydrogen, a linear or branched alkyl radical of one to eight carbon atoms or aryl, preferably an alkyl radical of one to four carbon atoms, particularly preferably methyl, ethyl, n-propyl, isopropyl, n-butyl, isobutyl, sec-butyl or tert-butyl.

However, it is also possible to use compounds having 1,4-benzoquinone as a parent compound. These can be described using the formula (VI) 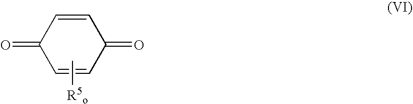
where
R⁵ is a linear or branched alkyl radical of one to eight carbon atoms, halogen or aryl, preferably an alkyl radical of one to four carbon atoms, particularly preferably methyl, ethyl, n-propyl, isopropyl, n-butyl, isobutyl, sec-butyl, tert-butyl, Cl, F or Br; and
o is an integer from one to four, preferably one or two.

Use is similarly made of phenols of the general structure (VII) 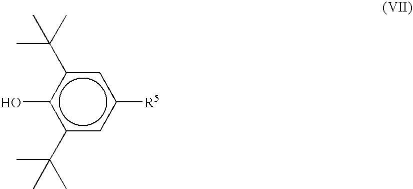
where
R⁵ is a linear or branched alkyl radical of one to eight carbon atoms, aryl or aralkyl, propionic esters with 1 to 4 hydric alcohols which may also contain heteroatoms such as S, O and N, preferably an alkyl radical of one to four carbon atoms, particularly preferably methyl, ethyl, n-propyl, isopropyl, n-butyl, isobutyl, sec-butyl, tert-butyl.

A further advantageous class of substances is that of the hindered phenols based on triazine derivatives of the formula (VIII) 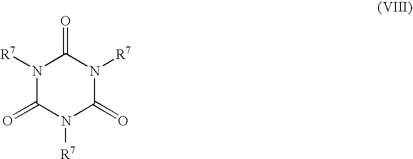
where R⁷=compound of formula (IX) 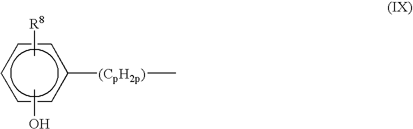
where
R⁸=CₚH₂ₚ₊₁
and p=1 or 2.

It is particularly successful to use the compounds 1,4-dihydroxybenzene, 4-methoxyphenol, 2,5-dichloro-3,6-dihydroxy-1,4-benzoquinone, 1,3,5-trimethyl-2,4,6-tris(3,5-di-tert-butyl-4-hydroxybenzyl)benzene, 2,6-di-tert-butyl-4-methylphenol, 2,4-dimethyl-6-tert-butylphenol, 2,2-bis[3,5-bis(1,1-dimethylethyl)-4-hydroxyphenyl-1-oxopropoxymethyl)]1,3-propanediyl ester, 2,2′-thiodiethyl bis[3-(3,5-di-tert-butyl-4-hydroxyphenyl)]propionate, octadecyl 3-(3,5-di-tert-butyl-4-hydroxyphenyl)propionate, 3,5-bis(1,1-dimethyl-ethyl-2,2-methylenebis(4-methyl-6-tert-butyl)phenol, tris-(4-tert-butyl-3-hydroxy-2,6-dimethylbenzyl)-s-tri-azine-2,4,6-(1H,3H,5H)trione, tris(3,5-ditert-butyl-4-hydroxy)-s-triazine-2,46-(1H,3H,5H)trione or tert-butyl-3,5-dihydroxybenzene.

As a proportion of the weight of the total reaction mixture, the inhibitors, reckoned individually or as a mixture, generally amount to 0.01-0.50% (wt/wt), the concentration of the inhibitors preferably being selected so that the DIN 55945 colour number is not impaired. Many of these inhibitors are commercially available.

The process of the invention provides a highly transparent plastic having very good mechanical properties. In a preferred embodiment of the present invention, the highly transparent plastic has an ISO 179/lfU Charpy impact toughness greater than 3.0 kJ/m².

The plastic of the invention is further notable for a high ISO 306 Vicat temperature, so that the plastic of the invention retains its excellent mechanical properties, especially its Charpy impact toughness and its hardness, at temperatures above room temperature. The ISO 306 Vicat temperature of the plastic according to the invention is preferably greater than 50° C., advantageously greater than 60° C. and especially greater than 70° C. ISO 306 Vicat temperatures greater than 80° C. and preferably greater than 90° C., advantageously greater than 100° C., especially greater than 120° C. are very particularly advantageous for the plastic according to the invention. In a very particularly preferred embodiment of the present invention, the plastics have an ISO 306 Vicat temperature of greater than 140° C., preferably greater than 160° C. and especially greater than 180° C.

Possible areas of use for the highly transparent plastic of the invention are evident to one skilled in the art. The highly transparent plastic of the invention is especially useful for all applications marked out for transparent plastics. Owing to its characteristic properties, the highly transparent plastic of the invention is particularly useful for optical lenses, especially for ophthalmic lenses.

The Inventive Examples B1 to B4 and Comparative Examples VB1 to VB3 hereinbelow serve to illustrate the invention without limiting it. The substances used in each case are reported in Table 1, the experimental details in Table 2 and the properties of the resultant product mixtures in Table 3.

### COMPARATIVE EXAMPLES VB1 to VB3 (AS PER DE 42 34 251)

A 4 l stirred apparatus is charged with the desired amount of methacrylic anhydride (MAA) stabilized with 500 ppm of 4-methyl-2,6-di-tert-butylphenol and 766 ml of the desired solvent. Concurrently, 94.2 g (1 mol) of 1,2-ethanedithiol are dissolved in the desired amount of 13% aqueous NaOH solution at 15-20° C. under nitrogen atmosphere. The sodium thiolate solution obtained is then added dropwise at the desired metering temperature in the course of 1 h with thorough stirring and with or without inertization. The batch is subsequently stirred under the desired supplementary reaction conditions.

To work up the reaction mixture, it is cooled down to room temperature, the lower, aqueous phase is separated off and the organic phase is extracted with 333 g of dilute ammonia (5%). This is followed by three washes with 333 g of DM water each time and clean separation. The crude ester solution is stabilized with a further 300 ppm of 4-methyl-2,6-di-tert-butylphenol and concentrated at max. 45° C. in a rotary evaporator.

### INVENTIVE EXAMPLES B1 AND B2

94.2 g (1 mol) of 1,2-ethanedithiol are weighed into a conical flask having a protective gas inlet and stirred and the desired amount of 13% NaOH solution is added at 25-30° C. in the course of 30 minutes with water cooling. A clear brownish solution forms.

The desired amount of MAA and the sodium thiolate solution are then added concurrently to the initially charged and stirred solvent/water in the reaction flask at the desired metering temperature in the course of 45 minutes. Protective gas is passed over the batch, if necessary. In general, the flask contents cool down by about 2° C. at the start of the addition, and about 5-10 minutes later a slightly exothermic reaction ensues, i.e. appropriate cooling is then applied to maintain the desired reaction temperature. On completion of the addition, the batch is further stirred under the desired reaction conditions and then cooled down to about 25° C. with stirring.

The batch is transferred into a separating funnel and separated and the lower, aqueous phase is dropped. The organic phase is extracted with 87.5 g of 5% aqueous phosphoric acid and subsequently washed twice with 50 g of DM water for neutralization.

The somewhat turbid to almost clear crude ester solution is then stabilized with 100 ppm of HQME and concentrated at max. 50° C. in a rotary evaporator. The end product is if appropriate admixed with 0.5% of diatomaceous earth at room temperature (20-25° C.) and stirred for about 10 minutes. This is followed by filtering through a Seitz K800 filter layer and a 0.45 μm filter membrane at about 1 bar.

### INVENTIVE EXAMPLES B3 AND B4

94.2 g (1 mol) of 1,2-ethanedithiol are weighed into a conical flask having a protective gas inlet and stirred and the desired amount of 13% NaOH solution is added at 25-30° C. in the course of 30 minutes with water cooling. A clear brownish solution forms.

The desired amount of MAA and the sodium thiolate solution are then added concurrently to the initially charged and stirred solvent/water in the reaction flask at the desired metering temperature in the course of 45 minutes. Protective gas is passed over the batch, if necessary. In general, the flask contents cool down by about 2° C. at the start of the addition, and about 5-10 minutes later a slightly exothermic reaction ensues, i.e. appropriate cooling is then applied to maintain the desired reaction temperature. On completion of the addition, the batch is further stirred under the desired reaction conditions and then cooled down to about 25° C. with stirring.

The batch is transferred into a separating funnel and separated and the lower, aqueous phase is dropped. To work up, the organic phase is transferred into a conical flask and stirred with Dowex M31 for about 15 minutes, after which the ion exchanger is filtered off.

The somewhat turbid to almost clear crude ester solution is then stabilized with 100 ppm of HQME and concentrated at max. 50° C. in a rotary evaporator. The colourless end product is if appropriate admixed with 0.5% of diatomaceous earth at room temperature (20-25° C.) and stirred for about 10 minutes. This is followed by filtering through a Seitz K800 filter layer and a 0.45 μm filter membrane at about 1 bar.

TABLE 1
substances used

| | 1,2-Ethanedithiol | MAA | NaOH | |
|---|---|---|---|---|
| | [mol] | [mol] | [mol} | Solvent |
| VB1 | 1 | 2.100 | 2.300 | Methyl tert-butyl ether |
| VB2 | 1 | 1.520 | 1.500 | Methyl tert-butyl ether |
| VB3 | 1 | 2.100 | 2.300 | Ethyl acetate |
| B1 | 1 | 1.520 | 1.760 | Ethyl acetate |
| B2 | 1 | 1.520 | 1.760 | Ethyl acetate |
| B3 | 1 | 1.450 | 1.692 | Ethyl acetate |
| B4 | 1 | 1.450 | 1.692 | Ethyl acetate |

TABLE 2
reaction conditions

| | | | | EDTDMA |
|---|---|---|---|---|
| | | | | concentration |
| | Metering | | Supplementary | in reaction |
| | temperature | Protective | reaction | solution |
| | [° C.] | gas | conditions | [% of theory] |
| VB1 | 10-15 | no | 3 h at 40° C. | 24.7 |
| VB2 | 20-25 | yes | 2 h at 40° C. | 25.0 |
| VB3 | 15-20 | no | 3 h at 40° C. | 23.0 |
| B1 | 40 | no | 2 h at 40° C. | 15.0 |
| B2 | 40 | yes | 2 h at 40° C. | 15.0 |
| B3 | 35 | yes | 5 min at 35° C. | 15.0 |
| B4 | 35 | yes | 5 min at 35° C. | 20.0 |

TABLE 3
characterization of product mixtures

| | | | MAA | EDTDMA | Monoadducts | Diadducts | Triadducts |
|---|---|---|---|---|---|---|---|
| | n_{D}²⁰ | Colour | [mol %] | [mol %] | [mol %] | [mol %] | [mol %] |
| VB1 | 1.5645 | colourless | | 52.3 | 27.4 | 6.6 | 5.8 |
| VB2 | 1.5600 | colourless | 4.5 | 58.5 | 23.3 | 6.3 | 2.4 |
| VB3 | 1.5571 | yellow | <1 | 71.4 | 18.9 | 2.6 | <1 |
| B1 | 1.5700 | yellow | <1 | 37.9 | 37.5 | 13.2 | 5.9 |
| B2 | 1.5704 | colourless | | 39.2 | 36.3 | 14.4 | 6.3 |
| B3 | 1.5733 | colourless | <1 | 29.6 | 38.8 | 13.9 | 8.0 |
| B4 | 1.5729 | colourless | <1 | 24.0 | 44.1 | 16.3 | 8.0 |

EDTDMA: 1,2-ethanedithiol dimethacrylate
Monoadducts: compounds as per formula (II) where R¹ = methyl; R² = 1,2-ethylene; m + n = 1
Diadducts: compounds as per formula (II) where R¹ = methyl; R² = 1,2-ethylene; m + n = 2
Triadducts: compounds as per formula (II) where R¹ = methyl; R² = 1,2-ethylene; m + n = 3

### POLYMERIZATION OF EXAMPLE B4

90 g of the oligomer mixture of Example B4 and 0.15% (135 mg) of t-butyl peroctoate are weighed out and dissolved. The batch is then introduced into a 200×150×3 mm chamber and polymerized.

| Temperature programme: | 20 h 62° C. in waterbath, |
|---|---|
| | 3 h 80° C. and 3 h 120° C. in |
| | heat cabinet. |
| Properties of resulting polymer: | |
| n_{D}²⁰ (as per DIN 53491 at λ = 589 nm): | 1.6169 |
| Abbe number (as per DIN 53491): | 38.9 |
| Charpy impact toughness (as per | 3.28 kJ/m² |
| ISO 179 1fU): | |
| Vicat temperature (as per ISO 306): | >180° C. |
| Transmission (as per DIN 5036): | 89.31% |

The comparative example of DE 42 34 251 (Example VI) has the following properties:

| | |
|---|---|
| n_{D}²⁰: | 1.6079 |
| Abbe number: | 35 |
| Impact toughness (only described | colourless |
| in qualitative terms): | rigid, somewhat |
| | brittle |
| | material |
| Vicat temperature: | not disclosed |
| Transmission: | not disclosed |

1. A process for preparing a transparent plastic, comprising polymerizing a mixture, comprising the compounds of the formula I and formula II 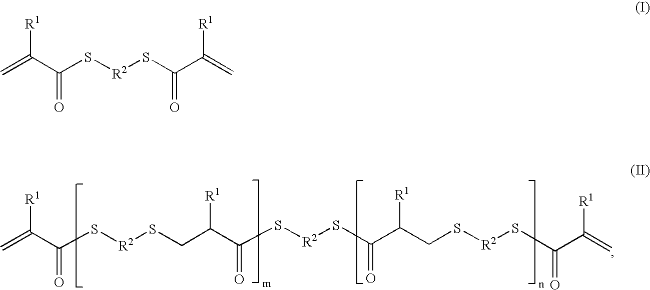
where R¹ is independently at each instance hydrogen or a methyl radical, R² is independently at each instance a linear or branched, aliphatic or cycloaliphatic radical or a substituted or unsubstituted aromatic or heteroaromatic radical, and m and n are each independently an integer of not less than 0, subject to the proviso that m+n>0, and
wherein they contain more than 10 mol %, based on the total amount of the compound as per formula (I) and (II), of compounds of the formula (II) where m+n=2, prepared by using 1.0 to less than 2.0 mol of a at least one compound of the formula (III) 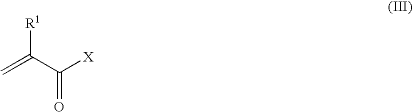
wherein X is chlorine or a radical 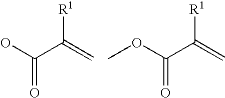
with one mole of at least one polythiol of the formula (IV) 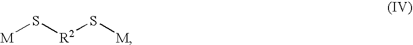
where M is independently at each instance hydrogen or a metal cation,
and in that a solvent L is acetone, acetonitrile, acetophenone, benzyl acetate, n-butyl acetate, quinoline, chlorobenzene, o-chlorotoluene, m-chlorotoluene, p-chlorotoluene, o-di-chlorobenzene, m-dichlorobenzene, diethyl ether, diisopropyl ether, dimethyl phthalate, dipropyl ether, ethyl acetate, ethyl benzoate, ethyl butyrate, ethyl formate, ethyl salicylate, isoquinoline, 2-methoxyethyl acetate, methyl acetate, methyl benzoate, methyl butyrate, methyl ethyl ketone, methyl formate, methyl isoamyl ketone, methyl isobutyl ketone, methyl propionate, 2-methylpyridine, N-methyl-2-pyrrolidone, methyl salicylate, nitrobenzene, o-nitrotoluene, m-nitrotoluene, p-nitrotoluene, 2-pentanone, 3-pentanone, phenyl acetate, propyl formate, pyridine, tetrahydrofuran or mixtures thereof.

2. The process according to claim 1, wherein the polymerization is carried out under protective gas atmosphere.

3. The process according to claim 1, wherein the at least one compound of the formula (III) is selected from acrylic anhydride, methacrylic anhydride or mixtures thereof.

4. The process according to claim 1, wherein the at least one polythiol of the formula (IV) is ethanedithiol.

5. The process according to claim 1, wherein the at least one compound of the formula (IV) is used in the form of an aqueous alkaline solution which contains 1.1 to 1.5 equivalents of at least one Bronsted base, based on the total amount of the at least one compound of the formula (III).

6. The process according to claim 1, wherein the at least one compound of the formula (III) and the at least one compound of the formula (IV) are concurrently metered into a reaction vessel in at least one inert organic solvent L and in an aqueous alkaline solution, respectively.

7. The process according to claim 1, wherein the polymerization is carried out at temperatures in the range from 20° C. to 80° C.

8. The process according to claim 1, wherein an acidic ion exchanger is used.

9. A transparent plastic prepared according to the process of claim 1.

10. An optical lens comprising the transparent plastic as claimed in claim 9.

11. The optical lens of claim 10, wherein the lens is an ophthalmic lens.

12. A process for preparing a mixture, comprising the compounds of the formula I and formula II 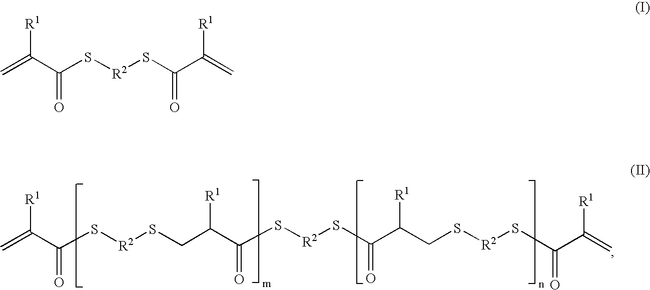
where R¹ is independently at each instance hydrogen or a methyl radical, R² is independently at each instance a linear or branched, aliphatic or cycloaliphatic radical or a substituted or unsubstituted aromatic or heteroaromatic radical, and m and n are each independently an integer of not less than 0, subject to the proviso that m+n>0, and
wherein they contain more than 10 mol %, based on the total amount of the compound as per formula (I) and (II), of compounds of the formula (II) where m+n=2, and
wherein said process comprising reacting 1.0 to less than 2.0 mol of at least one compound of the formula (III) 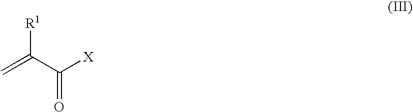
where X is chlorine or a radical 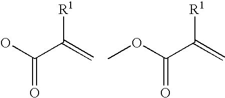
with one mole of at least one polythiol of the formula (IV) 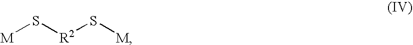
where M is independently at each instance hydrogen or a metal cation.

13. A mixture comprising the compounds of the formula I and formula II, prepared by the process of claim 12.

14. The process according to claim 12, wherein the reaction is carried out under protective gas atmosphere.

15. The process according to claim 12, wherein the at least one compound of the formula (III) is selected from acrylic anhydride, methacrylic anhydride or mixtures thereof.

16. The process according to claim 12, wherein the at least one polythiol of the formula (IV) is ethanedithiol.

17. The process according to claim 12, wherein the at least one compound of the formula (IV) is used in the form of an aqueous alkaline solution which contains 1.1 to 1.5 equivalents of at least one Bronsted base, based on the total amount of the at least one compound of the formula (III).

18. The process according to claim 12, wherein the at least one compound of the formula (III) and the at least one compound of the formula (IV) are concurrently metered into a reaction vessel in at least one inert organic solvent L and in an aqueous alkaline solution, respectively.

19. The process according to claim 12, wherein reaction is carried out at temperatures in the range from 20° C. to 80° C.

20. The process according to claim 12, wherein an acidic ion exchanger is used.
